(19) United States
(12) Patent Application Publication
(10) Pub. No.: US 2018/0210389 A1
(43) Pub. Date: Jul. 26, 2018

(54) IMAGE FORMING SYSTEM, JOB EXECUTION METHOD, AND COMPUTER READABLE STORAGE MEDIUM STORING JOB EXECUTION PROGRAM

(71) Applicant: Konica Minolta, Inc., Tokyo (JP)

(72) Inventor: Hiroyuki KONISHI, Tokyo (JP)

(73) Assignee: Konica Minolta, Inc., Tokyo (JP)

(21) Appl. No.: 15/857,809

(22) Filed: Dec. 29, 2017

(30) Foreign Application Priority Data
Jan. 26, 2017 (JP) 2017-012415

(51) Int. Cl. G03G 15/00; G06F 3/12; G03G 15/01; G03G 21/16

(52) U.S. Cl. CPC G03G 15/70; G06F 3/1237; G03G 2215/00552; G03G 21/1638; G03G 15/0142

(57) ABSTRACT

An image forming system that forms an image on the basis of a job, in a case that an operation mode is a first operation mode, performs a control to resume a job suspended because of the conveyance defect when a predetermined signal is recognized after the automatic purge process finishes, and in a case that the operation mode is a second operation mode, performs a control to continually resume a job suspended because of the conveyance defect without waiting for the predetermined signal to be recognized after the automatic purge process finishes.

### CROSS-REFERENCE TO RELATED APPLICATION

The entire disclosure of Japanese Patent Application No. 2017-012415 filed on Jan. 26, 2017, is incorporated herein by reference in its entirety.

### BACKGROUND

### 1. Technological Field

The present invention relates to an image forming system, a job execution method, and a non-transitory computer readable storage medium storing a job execution program.

### 2. Description of the Related Art

An image forming system includes an image forming apparatus that forms an image on a sheet of paper and a post-processing apparatus that performs a post-process on the sheet on which the image is formed by the image forming apparatus.

During job execution, in a case that a conveyance defect such as a paper jam occurs, the image forming system stops the conveyance of a sheet located in the conveyance path in the upper stream side of the sheet that caused the conveyance defect. Then, when the sheet that caused the conveyance defect is removed from the conveyance path by a user, the image forming system performs an automatic purge process that conveys a sheet remaining on the conveyance path and ejects it to the outside (for example, JP 2011-145558 A).

In the automatic purge process, the sheet remaining on the conveyance path are ejected to a paper eject tray as an ineffective sheet. When the automatic purge process is finished, the image forming system continually resumes the job suspended because of the conveyance defect.

Therefore, for example, in a case that the automatic purge process is performed, if only one paper eject tray is provided in the image forming system, the sheet ejected as the ineffective sheet by the automatic purge process is placed on the same paper eject tray as a sheet ejected before starting or after finishing the automatic purge process. When the sheet ejected by the automatic purge process as the ineffective sheet is placed on the same paper eject tray as other sheets, it is not desirable because unnecessary sheets are mixed with the printed matter.

### SUMMARY

The present invention is made in consideration of the abovementioned problem. Therefore, the object of the present invention is to provide an image forming system, a job execution method, and a non-transitory computer readable storage medium storing a job execution program, which are capable of preventing mixed placement of the sheet ejected by the automatic purge process and the sheet ejected before starting or after finishing the automatic purge process, regardless of the structure of the paper eject tray of the image forming system.

To achieve at least one of the abovementioned objects, according to an aspect of the present invention, an image forming system reflecting one aspect of the present invention is an image forming system that performs an image formation on the basis of a job, including: a paper conveyer that conveys a sheet along a conveyance path; an image former that is provided on the conveyance path and forms an image on a sheet conveyed along the conveyance path; a paper eject tray that is provided on an downstream side of the image former in a conveyance direction and onto which a sheet conveyed along the conveyance path is ejected; and a controller that recognizes a predetermined signal generated on the basis of a user action and, in a case that a conveyance defect occurs on a sheet conveyed on the conveyance path during job execution, controls the paper conveyer to perform an automatic purge process that conveys a sheet remaining on the conveyance path and ejects the sheet onto the paper eject tray after the sheet that caused the conveyance defect is removed from the conveyance path, wherein, the image forming system is configured to be able to switch an operation mode between a first operation mode and a second operation mode, and in a case that the operation mode is the first operation mode, the controller performs a control to resume the job suspended because of the conveyance defect when the predetermined signal is recognized after the automatic purge process finishes; and in a case that the operation mode is the second operation mode, the controller performs a control to continually resume the job suspended because of the conveyance defect without waiting for the predetermined signal to be recognized after the automatic purge process finishes.

To achieve at least one of the abovementioned objects, according to another aspect of the present invention, a job execution method reflecting another aspect of the present invention is a job execution method utilized in an image forming system, wherein the image forming system is configured to be able to switch an operation mode between a first operation mode and a second operation mode, and the method includes: (a) in a case that a conveyance defect occurs on a sheet conveyed on a conveyance path during job execution, performing an automatic purge process that conveys a sheet remaining on the conveyance path and ejects the sheet onto a paper eject tray after the sheet that caused the conveyance defect is removed from the conveyance path; (b) in a case that the operation mode is the first operation mode, recognizing a predetermined signal generated on the basis of a user action after the automatic purge process finishes and, when the predetermined signal is recognized, resuming the job suspended because of the conveyance defect; and (c) in a case that the operation mode is the second operation mode, after the automatic purge process finishes, continually resuming the job suspended because of the conveyance defect.

To achieve at least one of the abovementioned objects, according to further another aspect of the present invention, a non-transitory computer readable storage medium storing a job execution program reflecting further another aspect of the present invention is a non-transitory computer readable storage medium storing a job execution program to be executed on an image forming system, wherein the image forming system is configured to be able to switch an operation mode between a first operation mode and a second operation mode, and the program causes a computer to perform: (a) in a case that a conveyance defect occurs on a sheet conveyed on a conveyance path during job execution, performing a control to perform an automatic purge process that conveys a sheet remaining on the conveyance path and ejects the sheet onto a paper eject tray after the sheet that caused the conveyance defect is removed from the conveyance path; (b) in a case that the operation mode is the first operation mode, recognizing a predetermined signal generated on the basis of a user action after the automatic purge process finishes and, when the predetermined signal is recognized, performing a control to resume the job suspended because of the conveyance defect; and (c) in a case that the operation mode is the second operation mode, after the automatic purge process finishes, performing a control to continually resume the job suspended because of the conveyance defect.

The objects, features, and characteristics of this invention other than those set forth above will become apparent from the description given herein below with reference to preferred embodiments illustrated in the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing a schematic structure of the image forming system according to a first embodiment of the present invention.

FIG. 2 is a block diagram showing a schematic structure of the image forming apparatus.

FIG. 3 is a block diagram showing a schematic structure of the post-processing apparatus.

FIG. 4 is a flowchart showing a procedure of a printing process.

FIG. 5 is a subsequent flowchart of FIG. 4.

FIG. 6 is a flowchart showing a procedure of an operation mode determination process.

FIG. 7 is a diagram showing an example of a setting screen.

FIG. 8A is a diagram for describing an operation of the image forming system in a first operation mode.

FIG. 8B is a subsequent diagram of FIG. 8A.

FIG. 8C is a subsequent diagram of FIG. 8B.

FIG. 8D is a subsequent diagram of FIG. 8C.

FIG. 8E is a subsequent diagram of FIG. 8D.

FIG. 8F is a subsequent diagram of FIG. 8E.

FIG. 9A is a diagram showing an example of a screen displayed on an operation panel.

FIG. 9B is a subsequent diagram of FIG. 9A.

FIG. 9C is a subsequent diagram of FIG. 9B.

FIG. 9D is a subsequent diagram of FIG. 9C.

FIG. 9E is a subsequent diagram of FIG. 9D.

FIG. 10A is a diagram for describing an operation of the image forming system in a second operation mode.

FIG. 10B is a subsequent diagram of FIG. 10A.

FIG. 10C is a subsequent diagram of FIG. 10B.

FIG. 10D is a subsequent diagram of FIG. 10C.

FIG. 10E is a subsequent diagram of FIG. 10D.

FIG. 10F is a subsequent diagram of FIG. 10E.

FIG. 11A is a diagram showing an example of a screen displayed on an operation panel.

FIG. 11B is a subsequent diagram of FIG. 11A.

FIG. 11C is a subsequent diagram of FIG. 11B.

FIG. 11D is a subsequent diagram of FIG. 11C.

FIG. 11E is a subsequent diagram of FIG. 11D.

FIG. 12 is a diagram showing a schematic structure of the image forming system according to a second embodiment of the present invention.

FIG. 13 is a flowchart showing a procedure of an operation mode determination process.

FIG. 14A is a diagram for describing an operation of the image forming system.

FIG. 14B is a subsequent diagram of FIG. 14A.

FIG. 14C is a subsequent diagram of FIG. 14B.

FIG. 15A is a diagram showing an example of a screen displayed on an operation panel.

FIG. 15B is a subsequent diagram of FIG. 15A.

FIG. 15C is a subsequent diagram of FIG. 15B.

FIG. 16 is a diagram showing a schematic structure of the image forming system according to a third embodiment of the present invention.

FIG. 17 is a flowchart showing a procedure of an operation mode determination process.

FIG. 18A is a diagram for describing an operation of the image forming system.

FIG. 18B is a subsequent diagram of FIG. 18A.

FIG. 18C is a subsequent diagram of FIG. 18B.

FIG. 19A is a diagram showing an example of a screen displayed on an operation panel.

FIG. 19B is a subsequent diagram of FIG. 19A.

FIG. 19C is a subsequent diagram of FIG. 19B.

FIG. 20 is a diagram showing a schematic structure of the image forming system according to a fourth embodiment of the present invention.

FIG. 21 is a flowchart showing a procedure of an operation mode determination process.

FIG. 22A is a diagram for describing an operation of the image forming system.

FIG. 22B is a subsequent diagram of FIG. 22A.

FIG. 22C is a subsequent diagram of FIG. 22B.

FIG. 23A is a diagram showing an example of a screen displayed on an operation panel.

FIG. 23B is a subsequent diagram of FIG. 23A.

FIG. 23C is a subsequent diagram of FIG. 23B.

FIG. 24 is a flowchart showing a procedure of an operation mode determination process according to a fifth embodiment of the present invention.

FIG. 25 is a flowchart showing a procedure of an operation mode determination process according to a sixth embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

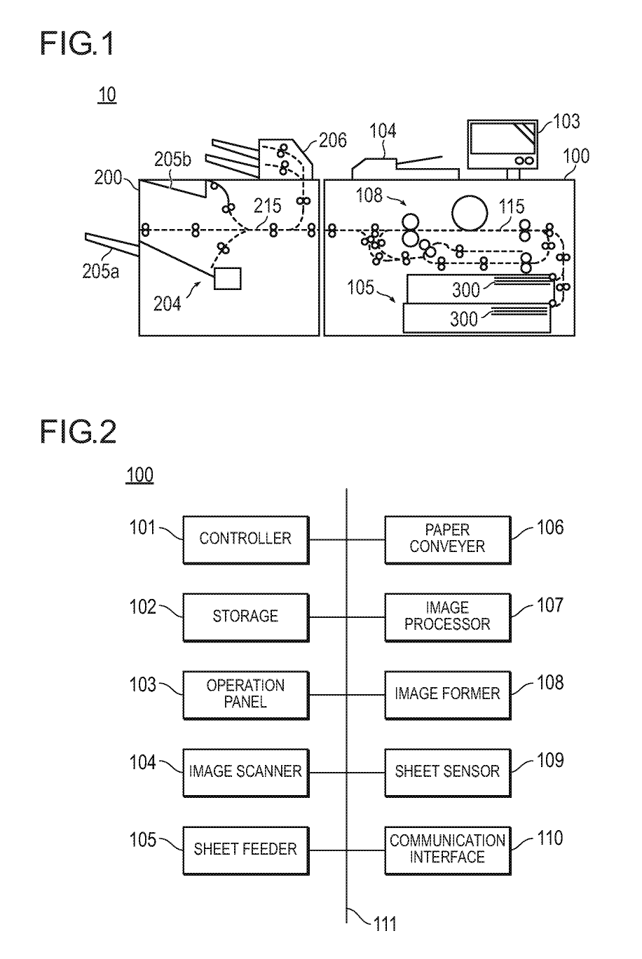

FIG. 1 is a diagram showing a schematic structure of the image forming system 10 according to a first embodiment of the present invention. The image forming system 10 includes an image forming apparatus 100 that forms an image on a sheet of paper and a post-processing apparatus 200 that performs a post-process on a sheet of paper on which an image is formed by the image forming apparatus 100. Hereinafter, the image forming apparatus 100 and the post-processing apparatus 200 are described in this order.

<Image Forming Apparatus>

FIG. 2 is a block diagram showing a schematic structure of the image forming apparatus 100. The image forming apparatus 100 includes a controller 101, a storage 102, an operation panel 103, an image reader 104, a paper feeder 105, a paper conveyer 106, an image processor 107, an image former 108, a sheet sensor 109, and a communication interface 110, and these are interconnected via a bus 111 for exchanging signals.

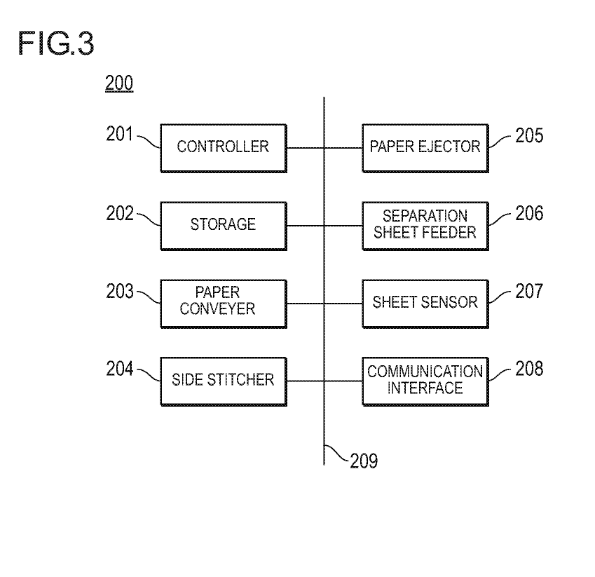

The controller 101 is a central processing unit (CPU), and it controls each of the abovementioned units and performs various computation processes according to a program. Also, the controller 101 communicates with a controller 201 of the post-processing apparatus 200 (refer to FIG. 3), and controls the operation of the post-processing apparatus 200. The controller 101 generates, as a printing control apparatus, image data for printing from printing data and the like described in a page description language.

The storage 102 includes a read only memory (ROM) for preliminarily storing various programs and various data, a random access memory (RAM) for temporarily storing a program and data as a workspace, a hard disk for storing various programs and various data, and the like.

The operation panel 103 includes a touch panel, a numeric keypad, start button, a stop button, and the like, and is used for displaying various information and inputting various instructions.

The image reader 104 emits light with a light source such as a fluorescent lamp at a document set at a predetermined reading position, and performs a photoelectric conversion with an imaging device such a charge coupled device (CCD) image sensor, and then generates image data from the electric signal.

The paper feeder 105 includes a plurality of sheet feed trays, and conveys one by one a sheet 300 accommodated in the sheet feed tray to the conveyance path 115.

The paper conveyer 106 includes a plurality of pairs of convey rollers that clamps and conveys the sheet 300, and conveys the sheet 300 provided by the paper feeder 105 along the conveyance path 115.

The image processor 107 performs various image processing to image data. The image processor 107 includes a dedicated image processing application specific integrated circuit (ASIC) and the like.

The image former 108 forms an image on the sheet 300 conveyed on the conveyance path 115 based on image data utilizing a known image formation process such as electrophotographic process and the like including steps of charging, exposure, development, transfer, and fixing.

A plurality of sheet sensors 109 are disposed on the conveyance path 115 of the image forming apparatus 100, and they detect the presence/absence of the sheet 300 at each position. The sheet sensor 109 is utilized to detect a conveyance defect such as a paper jam of the sheet 300.

The communication interface 110 is an interface for communicating with other devices, and it sends and receives, with the post-processing apparatus 200, setting values and various signals necessary for operation timing control. Also, the communication interface 110 receives the printing data and the like described in a page description language from an external personal computer (PC).

The controller 101 of the image forming apparatus 100 functions as a recognition unit and a setting unit by executing a corresponding program. Here, the recognition unit recognizes a signal generated when the start button on the operation panel 103 is pressed by a user. The setting unit sets an operation mode of the image forming system 10 on the basis of a user operation. The detailed processing content of each unit will be described later.

<Post-Processing Apparatus>

FIG. 3 is a block diagram showing a schematic structure of the post-processing apparatus 200. The post-processing apparatus 200 includes a controller 201, a storage 202, a paper conveyer 203, a side stitcher 204, a paper ejector 205, a separation sheet feeder 206, a sheet sensor 207, and a communication interface 208, and these are interconnected via a bus 209 for exchanging signals. Here, among the above-described units of the post-processing apparatus 200, the descriptions of the portions that have the same function as each of the above-described units of the image forming apparatus 100 are omitted.

The side stitcher 204 includes a stacker that stacks the sheet 300 and a stapler that staples a bundle of the sheets 300. The side stitcher 204 side-stitches the bundle of sheets 300 and forms a booklet by stapling an end of the bundle of sheets 300.

The paper ejector 205 includes a paper eject tray onto which the sheet 300 conveyed on the conveyance path 215 of the post-processing apparatus 200 is ejected. The paper ejector 205 of the present embodiment includes a main paper eject tray 205a provided at a side of the post-processing apparatus 200 and a sub paper eject tray 205b provided at a top of the post-processing apparatus 200.

The separation sheet feeder 206 feeds a separation sheet to the conveyance path 215. The separation sheet feeder 206 can provide the separation sheet between designated sheets that are conveyed on the conveyance path 215.

The image forming apparatus 100 and the post-processing apparatus 200 may include other components than the above-described components, or need not include one or more of the above-described components.

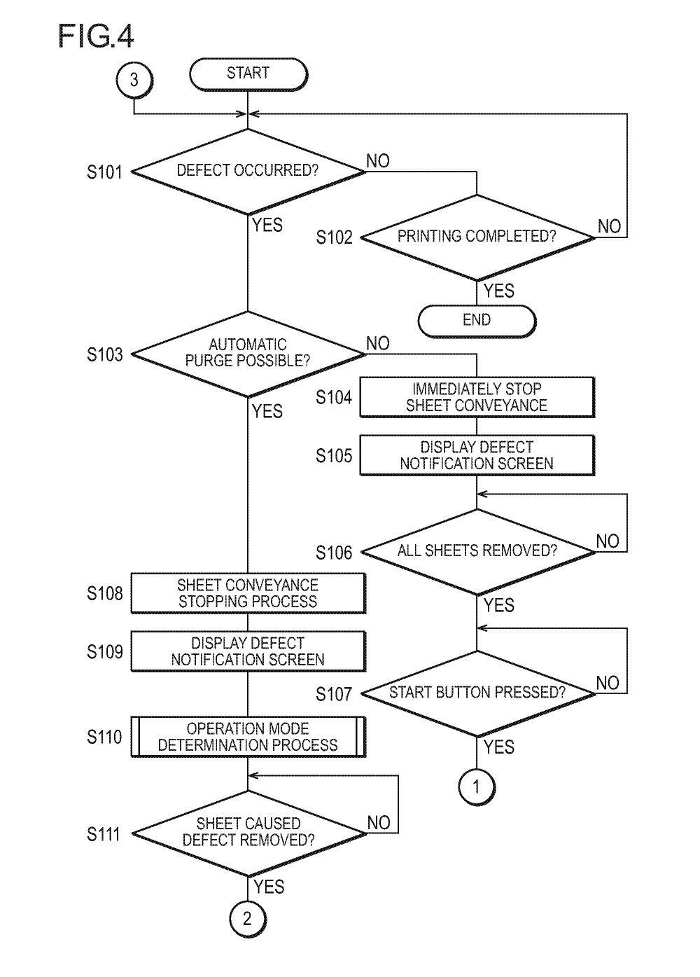

The image forming system 10 as described above performs an automatic purge process when a conveyance defect such as a paper jam occurs during job execution. More specifically, the image forming system 10 suspends a conveyance of a sheet 300 located on upper stream side of the sheet 300 that caused the conveyance defect on the conveyance path, and after a user removes the sheet 300 that caused the conveyance defect, conveys and ejects the sheet 300 remaining on the conveyance path to the outside as an ineffective sheet. When the automatic purge process finishes, the image forming system 10 resumes the job suspended because of the conveyance defect. Hereinafter, an operation of the image forming system 10 is described in details with reference to FIG. 4 to FIG. 11E.

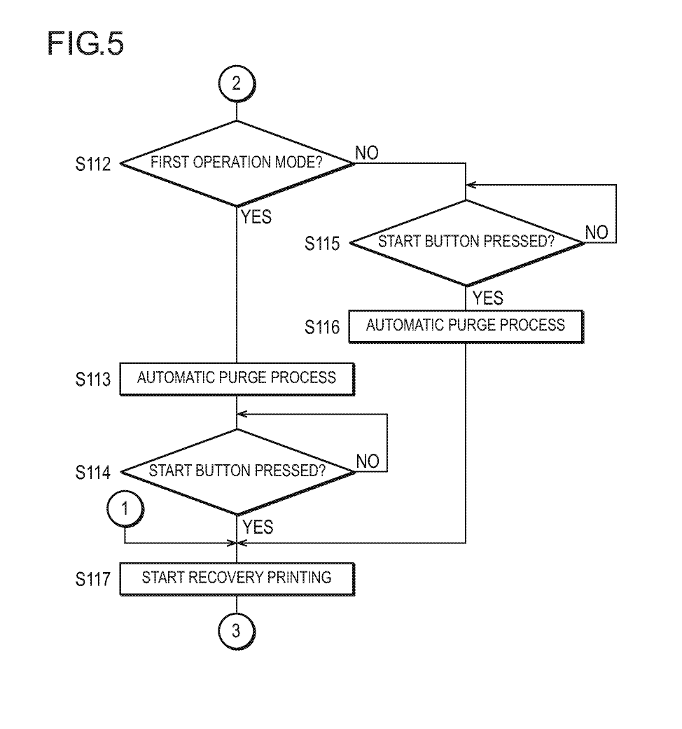

FIG. 4 and FIG. 5 are flowcharts showing a procedure of a printing process executed by the image forming system 10. Here, the algorithm shown by the flowcharts of FIG. 4 and FIG. 5 are stored as a program on the storage 102 of the image forming apparatus 100, and is executed by the controller 101 of the image forming apparatus 100.

When a printing process is started, the controller 101 firstly determines whether a conveyance defect such as a paper jam has occurred or not for a sheet 300 that is being conveyed on the conveyance paths 115 and 215 (step S101).

When it is determined that a conveyance defect of the sheet 300 has occurred (step S101: YES), the controller 101 transfers to a process of step S103. On the other hand, when it is determined that a conveyance defect of the sheet 300 has not occurred (step S101: NO), the controller 101 determines whether the printing process has finished or not (step S102).

When it is determined that the printing process has finished (step S102: YES), the controller 101 ends the process. On the other hand, when it is determined that the printing process has not finished (step S102: NO), the controller 101 returns to the process of step S101.

On the other hand, in the process shown in the step S101, when it is determined that a conveyance defect of the sheet 300 has occurred (step S101: YES), the controller 101 determines whether the automatic purge process is possible or not on the basis of the position of the sheet 300 on the conveyance paths 115 and 215, and the size of the sheet 300 (step S103).

When it is determined that the automatic purge process is possible, (step S103: YES), the controller 101 transfers to a process of step S108. On the other hand, when it is determined that the automatic purge process is not possible (step S103: NO), the controller 101 controls the image forming apparatus 100 and the post-processing apparatus 200 to immediately stop the conveyance of the sheet 300 (step S104).

Then, the controller 101 displays a defect notification screen promoting the user to remove all the sheets 300 remaining on the conveyance paths 115 and 215 on the operation panel 103 (step S105). The user who sees the defect notification screen removes all the sheets 300 remaining on the conveyance paths 115 and 215 in accordance with the guidance information on the defect notification screen.

Then, the controller 101 determines whether all the sheets on the conveyance paths 115 and 215 are removed by the user or not (step S106). When it is determined that not all the sheets 300 are removed (step S106: NO), the controller 101 waits until all the sheets 300 are removed.

On the other hand, when it is determined that all the sheets 300 are removed (step S106: YES), the controller 101 determines whether the start button on the operation panel 103 is pressed by the user or not (step S107).

When it is determined that the start button is not pressed (step S107: NO), the controller 101 waits until the start button is pressed. On the other hand, when it is determined that the start button is pressed (step S107: YES), the controller 101 starts a recovery printing (step S117), and then returns to the process of step S101. More specifically, the controller 101 controls the image forming apparatus 100 and the post-processing apparatus 200 to resume the printing process that has been suspended because of the conveyance defect of the sheet 300.

As described above, in the processes shown in steps S101 to S107 and S117, whether the automatic purge process is possible or not is determined when a conveyance defect of a sheet 300 occurs during job execution. Moreover, when it is determined that the automatic purge process is not possible, the user is promoted to remove all the sheets 300 on the conveyance paths 115 and 215. Then, after all the sheets 300 on the conveyance paths 115 and 215 are removed by the user, the job that has been suspended because of the conveyance defect of the sheet 300 is resumed.

On the other hand, in the process shown in the step S103, when it is determined that the automatic purge process is possible (step S103: YES), the controller 101 performs a sheet conveyance stopping process that stops the sheet 300 in the image forming system 10 at a predetermined stop position (step S108). Here, since the sheet conveyance stopping process itself is a known technique, the description of the sheet conveyance stopping process is omitted.

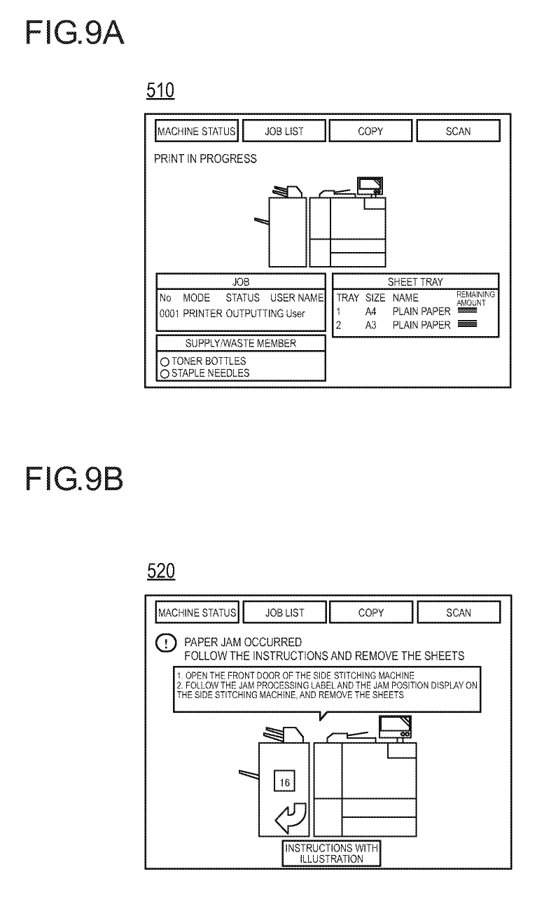

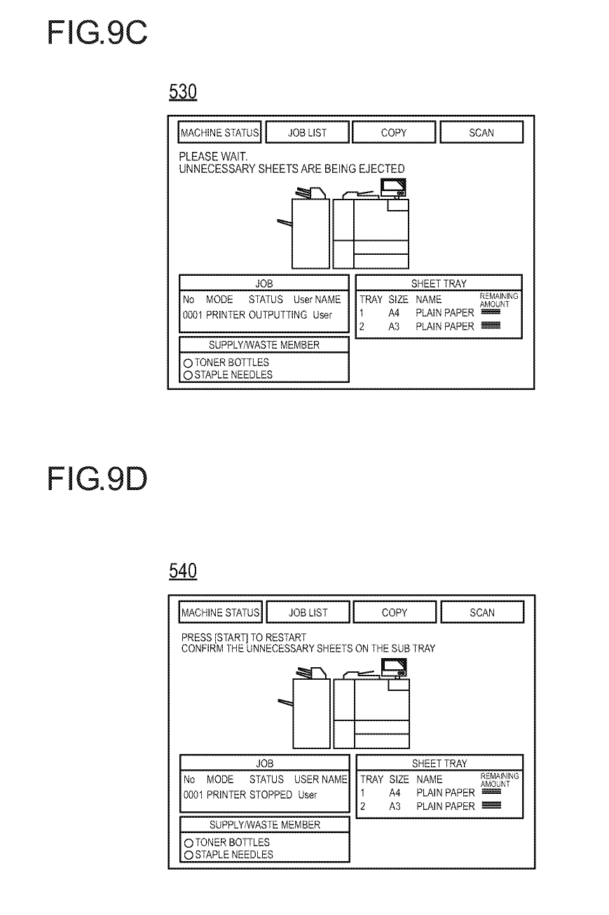

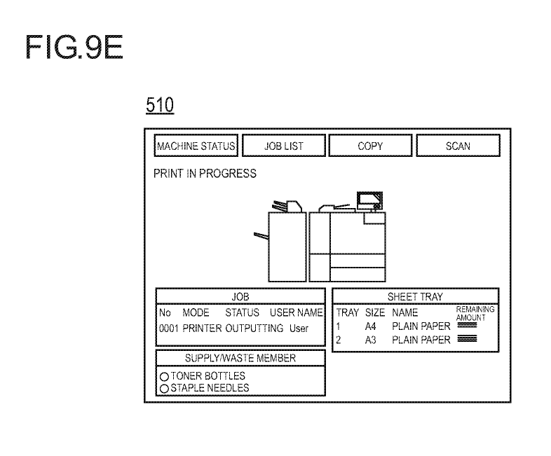

Then, the controller 101 displays a defect notification screen 520 (refer to FIG. 9B) promoting the user to remove the sheet 300 that caused the conveyance defect on the operation panel 103 (step S109). The user who sees the defect notification screen 520 removes the sheet 300 that caused the conveyance defect from the image forming system 10 in accordance with the guidance information on the defect notification screen 520.

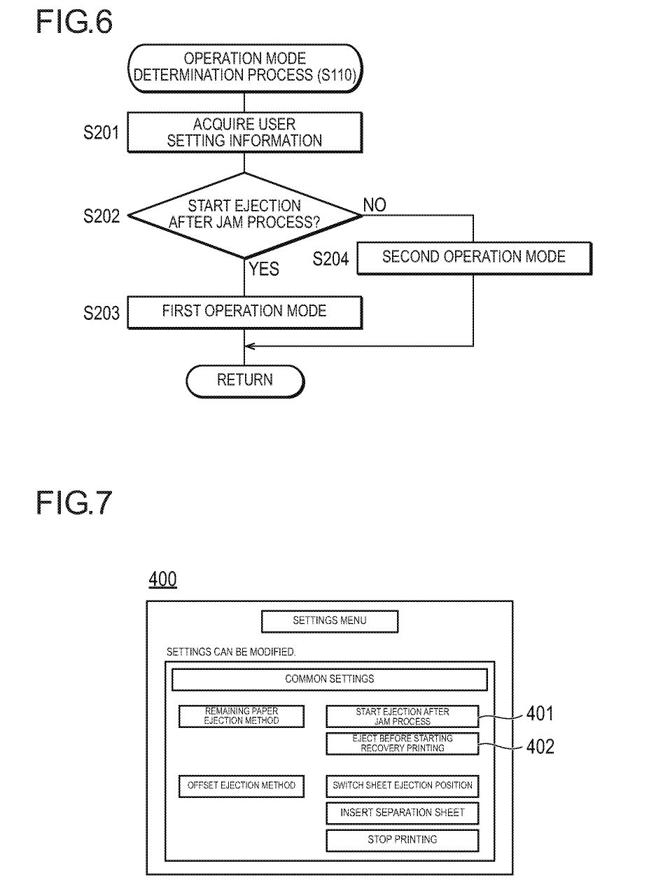

Then, the controller 101 performs an operation mode determination process that determines the operation mode of the image forming system 10 (step S110). Here, the image forming system 10 of the present embodiment is configured to be able to switch an operation mode between a first operation mode and a second operation mode. Step S110 will be described in detail using FIG. 6, leaving from the description of FIG. 4 and FIG. 5 one time.

FIG. 6 is a flowchart showing a procedure of the operation mode determination process.

Firstly, the controller 101 acquires user setting information showing an operation mode set by a user (step S201). In the present embodiment, an operation mode of the image forming system 10 is preliminarily set on the basis of a user operation through a setting screen 400 (refer to FIG. 7). Here, when the “start ejection after jam process” button 401 on the setting screen 400 is selected, the first operation mode is set, and when the “eject before starting recovery printing” button 402 is selected, the second operation mode is set.

Then, the controller 101 determines whether the “start ejection after jam process” button 401 is selected or not (step S202). When it is determined that the “start ejection after jam process” button 401 is selected (step S202: YES), the controller 101 determines the operation mode of the image forming system 10 as the first operation mode (step S203), and ends the process.

On the other hand, when it is determined that the “start ejection after jam process” button 401 is not selected (step S202: NO), the controller 101 regards that the “eject before starting recovery printing” button 402 is selected, and determines the operation mode of the image forming system 10 as the second operation mode (step S204), and ends the process.

As described above, in the operation mode determination process shown in step S110, the user setting information is referred to, and the operation mode of the image forming system 10 is determined as the operation mode that has been set on the basis of the user operation.

Coming back to the description of FIG. 4, the controller 101 determines whether the sheet 300 that caused the conveyance defect is removed from the image forming system 10 by the user or not (step S111). When it is determined that the sheet 300 that caused the conveyance defect is not removed from the image forming system 10 (step S111: NO), the controller 101 waits until the sheet 300 that caused the conveyance defect is removed from the image forming system 10.

On the other hand, when it is determined that the sheet 300 that caused the conveyance defect is removed from the image forming system 10 (step S111: YES), the controller 101 determines whether the operation mode of the image forming system 10 that has been determined at the operation mode determination process shown in step S110 is the first operation mode or not (step S112).

When it is determined that the operation mode of the image forming system 10 is not the first operation mode (step S112: NO), the controller 101 transfers to a process of step S115. On the other hand, when it is determined that the operation mode of the image forming system 10 is the first operation mode (step S112: YES), the controller 101 performs the automatic purge process for the sheet 300 (step S113). More specifically, the controller 101 controls the image forming apparatus 100 and the post-processing apparatus 200 to convey the sheet 300 that has been stopped in the image forming system 10 by the sheet conveyance stopping process shown in the step S108, and eject onto the paper eject tray.

Then, the controller 101 determines whether the start button on the operation panel 103 is pressed by the user or not (step S114). When it is determined that the start button is not pressed (step S114: NO), the controller 101 waits until the start button is pressed. On the other hand, when it is determined that the start button is pressed (step S114: YES), the controller 101 starts a recovery printing (step S117), and then returns to the process of step S101.

As described above, in the processes shown in the steps S108 to S114 and S117, when a conveyance defect of a sheet 300 occurs during job execution, in the case that the automatic purge process is possible, the operation mode of the image forming system 10 is determined. Moreover, in the case that the operation mode of the image forming system 10 is the first operation mode, the job suspended because of the conveyance defect of the sheet 300 is resumed when the start button is pressed by the user after the automatic purge process finishes.

On the other hand, in the process shown in the step S112, when it is determined that the operation mode of the image forming system 10 is not the first operation mode (step S112: NO), the controller 101 regards the operation mode of the image forming system 10 as the second operation mode, and determines whether the start button on the operation panel 103 is pressed by the user or not (step S115).

When it is determined that the start button is not pressed (step S115: NO), the controller 101 waits until the start button is pressed. On the other hand, when it is determined that the start button is pressed (step S115: YES), the controller 101 performs the automatic purge process (step S116). When the automatic purge process finishes, the controller 101 starts the recovery printing (step S117), and returns to the process of step S101.

As described above, in the processes of the steps S115 to S117, in the case that the operation mode of the image forming system 10 is the second operation mode, the job suspended because of the conveyance defect of the sheet 300 is resumed without waiting the user to press the start button after the automatic purge process finishes.

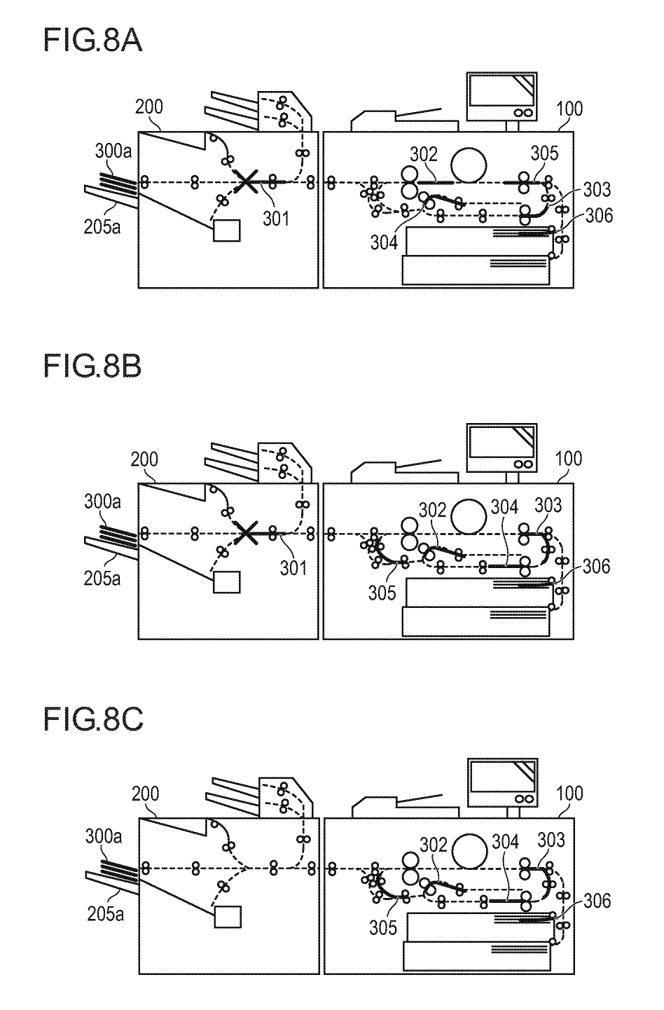

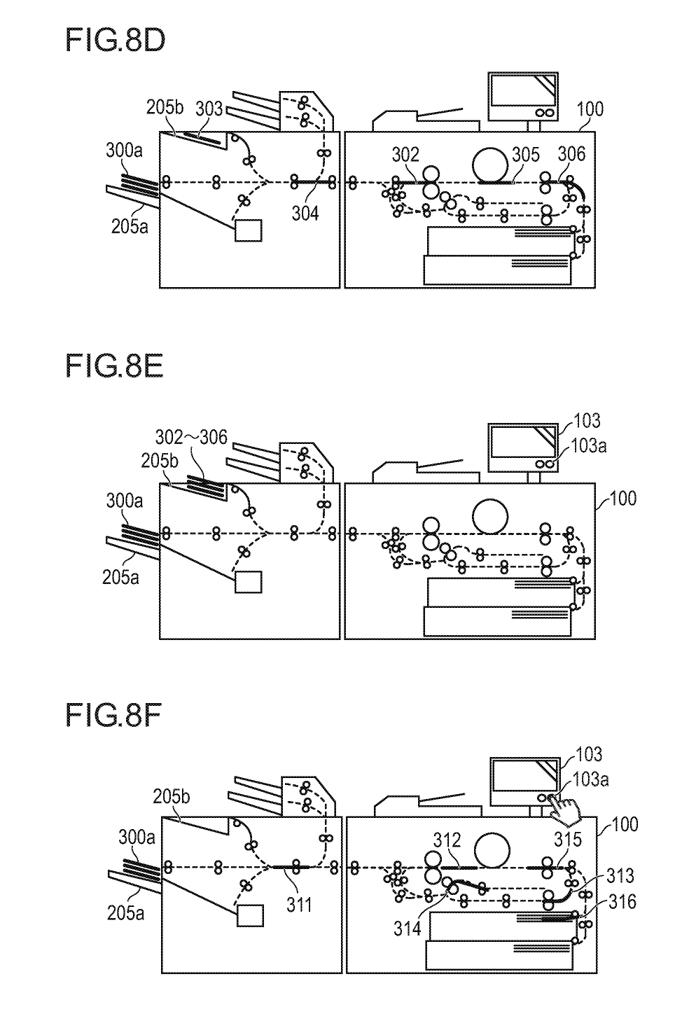

Next, with reference to FIG. 8A to FIG. 11E, an operation of the image forming system 10 in a case that a conveyance defect of a sheet 300 occurs is described more specifically.

<First Operation Mode>

With reference to FIG. 8A to FIG. 9E, the operation of the image forming system 10 in the first operation mode is described. FIG. 8A to FIG. 8F are diagrams for describing an example of the operation of the image forming system 10, and FIG. 9A to FIG. 9E are diagrams showing an example of the screen displayed on the operation panel 103 of the image forming apparatus 100.

As shown in FIG. 8A, it is assumed that, during job execution, a paper jam of a sheet 301 has occurred at a position marked with “X” sign along the conveyance path 215 in the post-processing apparatus 200. In this case, as shown in FIG. 8B, the image forming system 10 executes the sheet conveyance stopping process, and moves the sheets 302 to 306 that exist on the upper stream side of the sheet 301 that caused the paper jam on the conveyance path 115 to a predetermined stop position and stops.

Then, the image forming system 10 switches the screen displayed on the operation panel 103 from a screen 510 showing that the printing is in progress (refer to FIG. 9A) to the defect notification screen 520 notifying the paper jam (refer to FIG. 9B). The defect notification screen 520 includes information that promotes the user to remove the sheet that caused the paper jam, and guidance information showing a procedure to remove the sheet that caused the paper jam. The user removes the sheet 301 from the image forming system 10, referring to the guidance information on the defect notification screen 520. As a result, as shown in FIG. 8C, the sheet 301 does not exist on the conveyance path 215 of the image forming system 10.

When the sheet 301 does not exist on the conveyance path 215, as shown in FIG. 8D, the image forming system 10 performs the automatic purge process, and ejects the sheets 302 to 306 that are remaining on the conveyance path 115 onto the sub paper eject tray 205b. During this period, the operation panel 103 displays a screen 530 showing that the sheets 302 to 306 are being ejected as ineffective sheets (unnecessary paper) (refer to FIG. 9C). Here, for example, the image forming system 10 starts the automatic purge process by using the nondetection of the sheet 301 by the sheet sensor 207 on the conveyance path 215 as a trigger.

When the automatic purge process finishes, as shown in FIG. 8E, the image forming system 10 waits until a start button 103a on the operation panel 103 is pressed by the user. During this period, the operation panel 103 displays a screen 540 showing that the job resumes when the start button 103a is pressed (refer to FIG. 9D).

When the sheets 302 to 306 that are ejected onto the sub paper eject tray 205b are removed by the user, and the start button 103a is pressed, as shown in FIG. 8F, the image forming system 10 starts the recovery printing, and resumes the job suspended because of the paper jam. More specifically, the image forming system 10 executes a remaining part of the job including re-printing of the sheet 301 that has caused the paper jam and the sheets 302 to 306 that have been ejected by the automatic purge process. Here, a sheet 311 shown in FIG. 8F corresponds to the sheet 301 that caused the paper jam, and sheets 312 to 316 correspond to the sheets 302 to 306 that have been ejected as ineffective sheets by the automatic purge process. When the recovery printing starts, the operation panel 103 displays the screen 510 showing that the printing is in progress (refer to FIG. 9E) again.

As described above, in the first operation mode, when the conveyance defect of the sheet 300 occurs during job execution, the image forming system 10 performs the automatic purge process after the sheet 301 that caused the conveyance defect is removed by the user. When the automatic purge process finishes, the image forming system 10 waits until the start button 103a on the operation panel 103 is pressed by the user. After that, when the user presses the start button 103a, the image forming system 10 resumes the job that has been suspended because of the conveyance defect. With the described configuration, when the automatic purge process finishes, the job will not resume unless the start button 103a is pressed, so the user can remove the sheets ejected as ineffective sheets by the automatic purge process from the paper eject tray before the job resumes. Therefore, for example, in a case that only one paper eject tray is provided, a case that an unnecessary sheet is mixed in the printed matter is prevented.

<Second Operation Mode>

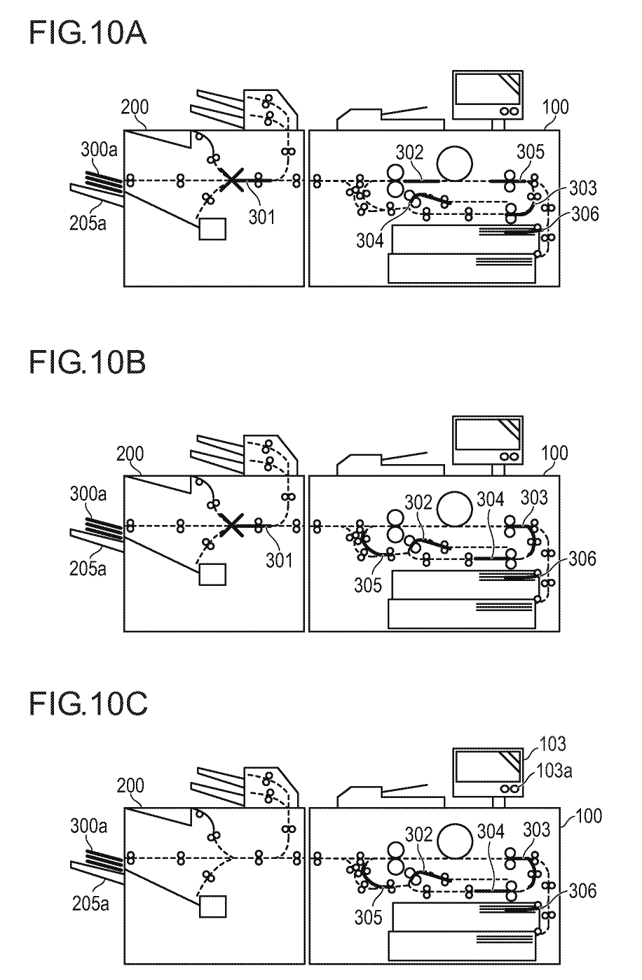

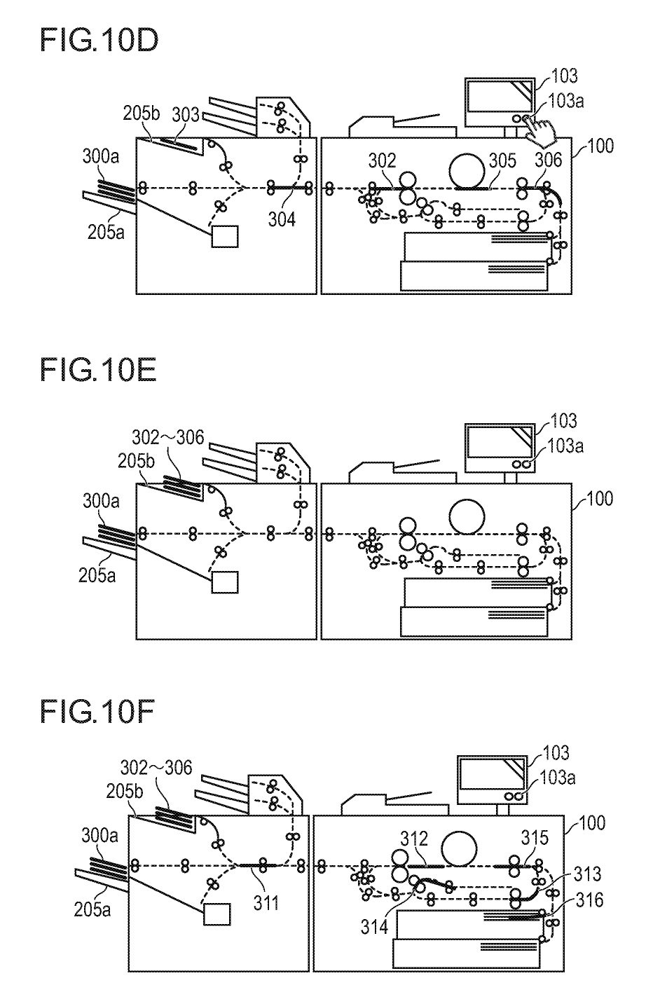

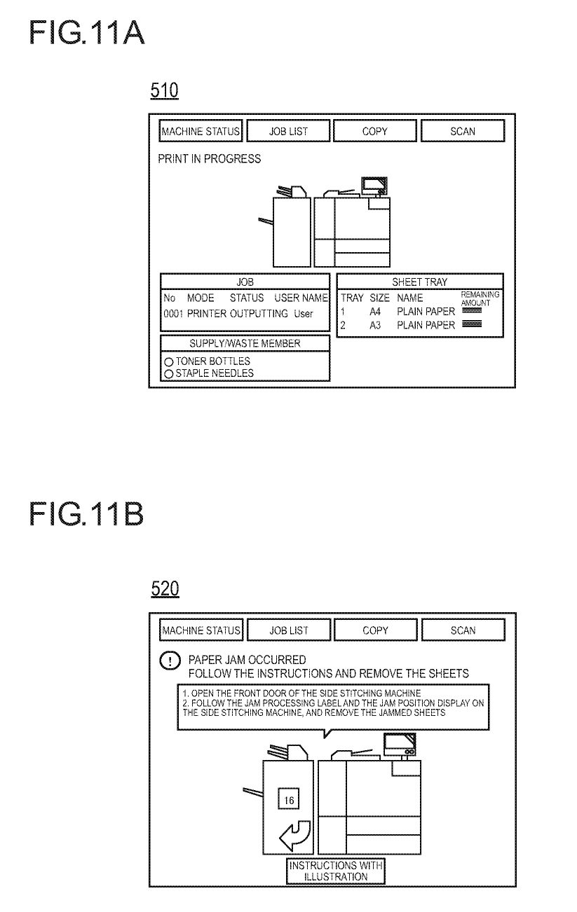

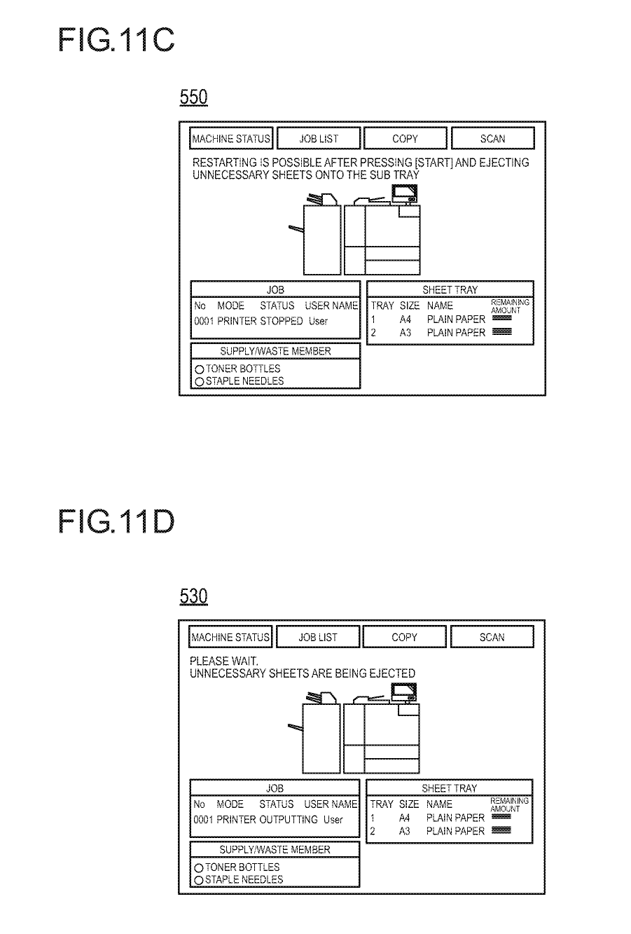

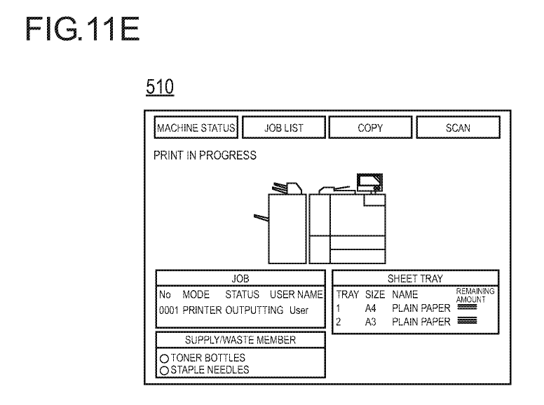

Next, with reference to FIG. 10A to FIG. 11E, the operation of the image forming system 10 in the second operation mode is described. FIG. 10A to FIG. 10F are diagrams for describing an example of the operation of the image forming system 10, and FIG. 11A to FIG. 11E are diagrams showing an example of the screen displayed on the operation panel 103 of the image forming apparatus 100.

As shown in FIG. 10A, it is assumed that, during job execution, a paper jam of sheet 301 has occurred at a position marked with “X” sign along the conveyance path 215 in the post-processing apparatus 200. In this case, as shown in FIG. 10B, the image forming system 10 executes the sheet conveyance stopping process, and moves the sheets 302 to 306 that exist on the upper stream side of the sheet 301 that caused the paper jam on the conveyance path 115 to a predetermined stop position and stops.

Then, the image forming system 10 switches the screen displayed on the operation panel 103 from the screen 510 showing that the printing is in progress (refer to FIG. 11A) to the defect notification screen 520 notifying the paper jam (refer to FIG. 11B). The user removes the sheet 301 from the image forming system 10, referring to the guidance information on the defect notification screen 520. As a result, as shown in FIG. 10C, the sheet 301 does not exist on the conveyance path 215 of the image forming system 10.

When the sheet 301 does not exist on the conveyance path 215, the image forming system 10 waits until the start button 103a on the operation panel 103 is pressed by the user. During this period, the operation panel 103 displays a screen 550 showing that the automatic purge process is performed and the job resumes when the start button 103a is pressed (refer to FIG. 11C).

When the user presses the start button 103a, as shown in FIG. 10D and FIG. 10E, the image forming system 10 performs the automatic purge process, and ejects the sheets 302 to 306 that are remaining on the conveyance path 115 onto the sub paper eject tray 205b. During this period, the operation panel 103 displays the screen 530 showing that the sheets 302 to 306 are being ejected as ineffective sheets (refer to FIG. 11D).

When the automatic purge process finishes, as shown in FIG. 10F, the image forming system 10 immediately starts the recovery printing and resumes the job that has been suspended because of the paper jam. More specifically, the image forming system 10 executes a remaining part of the job including re-printing of the sheet 301 that has caused the paper jam and the sheets 302 to 306 that have been ejected by the automatic purge process. When the recovery printing starts, the operation panel 103 displays the screen 510 showing that the printing is in progress (refer to FIG. 11E) again.

As described above, in the second operation mode, when the conveyance defect of the sheet 300 occurs during job execution, after the sheet 301 that caused the conveyance defect is removed by the user, the image forming system 10 waits until the start button 103a on the operation panel 103 is pressed by the user. Then, when the start button 103a is pressed by the user, the image forming system 10 performs the automatic purge process, and after the automatic purge process finishes, continually resumes the job. With the described configuration, the user can press the start button 103a and then immediately go away from the front of the image forming system 10 after removing the sheet 301 that caused the paper jam from the image forming system 10 (after jam process).

As described above, the image forming system 10 of the present embodiment is configured to be able to switch the operation mode between the first operation mode and the second operation mode. Moreover, when a conveyance defect such as a paper jam occurs, the controller 101 of the image forming apparatus 100 sets the operation mode of the image forming system 10 to the operation mode set by the user operation. With the described configuration, the operation mode can be switched depending on a use environment (office/commercial printing) or an optional configuration of the image forming system 10, so that the user convenience improves.

Here, in a case that the image forming system 10 is used at an office, since it is not desirable that a user stays in front of the image forming system 10 for a long time, the operation mode of the image forming system 10 is set to the second operation mode, for example. On the other hand, when the image forming system 10 is used for commercial printing, in many cases a dedicated operator exists, so the first operation mode is set as the operation mode of the image forming system 10.

### Second Embodiment

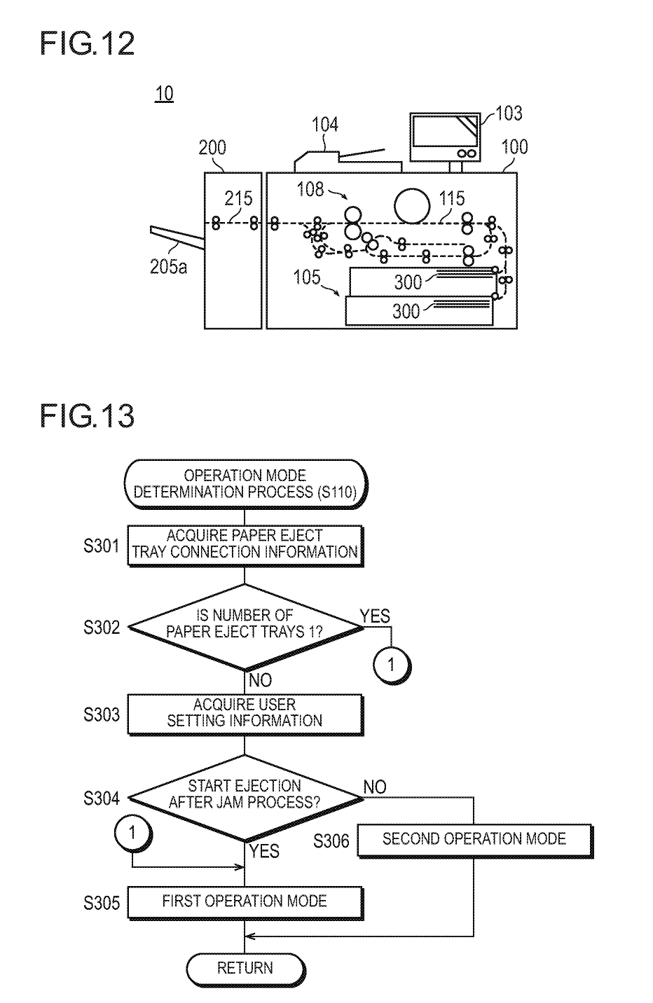

Next, with reference to FIG. 12 to FIG. 15C, the second embodiment of the present invention is described. In the present embodiment, the operation mode of the image forming system 10 is switched in accordance with the number of the paper eject trays of the post-processing apparatus 200.

FIG. 12 is a diagram showing a schematic structure of the image forming system 10 according to the present embodiment. The image forming system 10 includes an image forming apparatus 100 that forms an image on a sheet of paper and a post-processing apparatus 200 that performs a post-process on a sheet of paper on which an image is formed by the image forming apparatus 100. The post-processing apparatus 200 of the present embodiment does not include a sub paper eject tray 205b, and only includes a main paper eject tray 205a.

FIG. 13 is a flowchart showing a procedure of an operation mode determination process according to the present embodiment. Here, the printing process itself according to the present embodiment is the same as that of the first embodiment, so the description about the printing process is omitted.

Firstly, the controller 101 acquires paper eject tray connection information showing the configuration of the paper eject tray included in the image forming system 10 (step S301).

Then, the controller 101 determines whether the number of paper eject trays included in the image forming system 10 is one or not, referring to the paper eject tray connection information (step S302).

When it is determined that the number of paper eject trays is one (step S302: YES), the controller 101 determines the operation mode of the image forming system 10 as the first operation mode (step S305), and ends the process.

On the other hand, when it is determined that the number of paper eject trays is not one (step S302: NO), the controller 101 acquires user setting information (step S303). The process of step S303 and after is the same as the process of step S201 and after in FIG. 6, so the detailed description is omitted.

As described above, in the process shown in the flowchart of FIG. 13, whether the number of the paper eject trays included in the image forming system 10 is one or not is determined at first. Then, when it is determined that the number of paper eject trays is one, the operation mode of the image forming system 10 is determined as the first operation mode. On the other hand, when it is determined that the number of paper eject trays included in the image forming system 10 is plural, the operation mode of the image forming system 10 is determined as the operation mode set by the user operation.

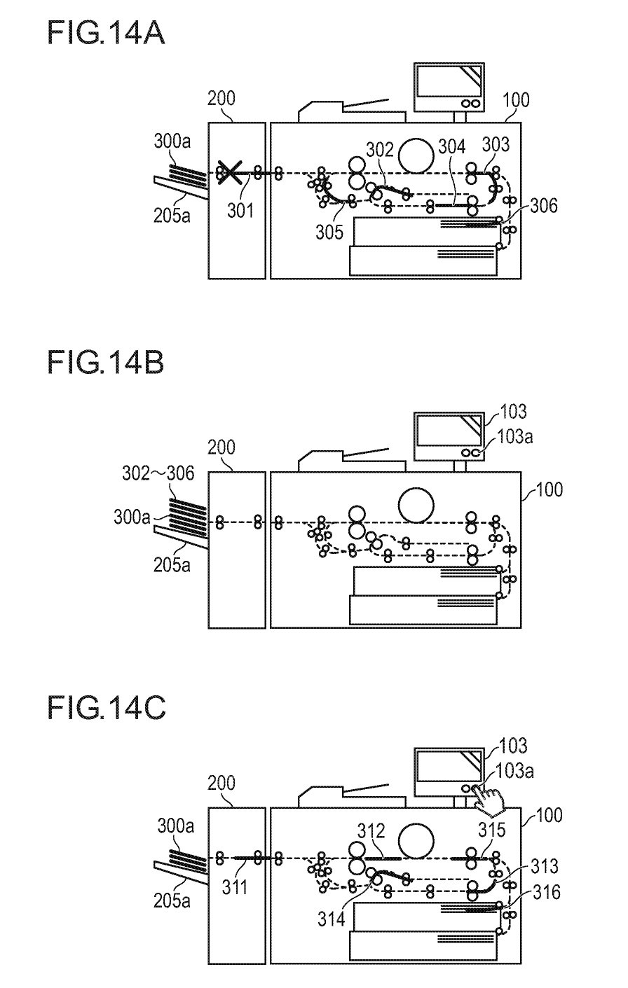

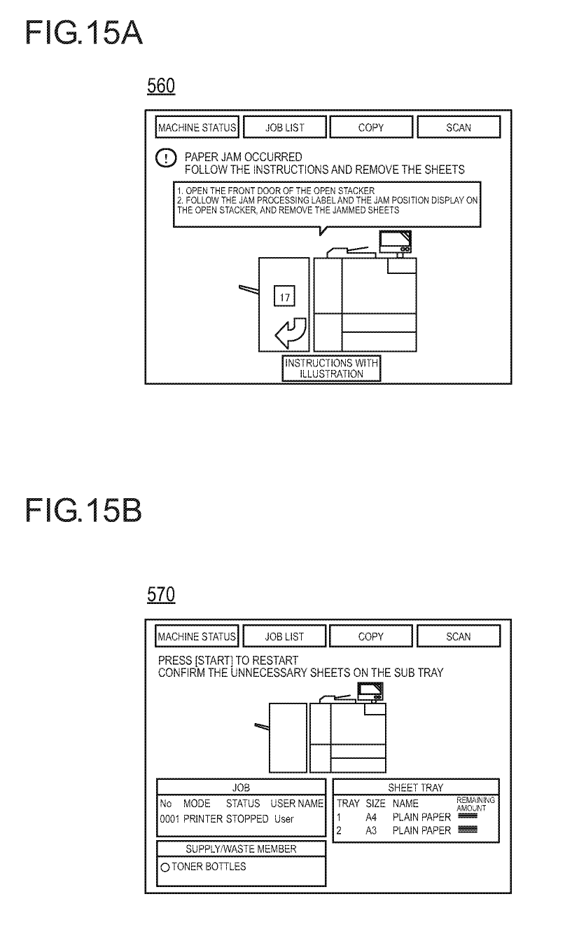

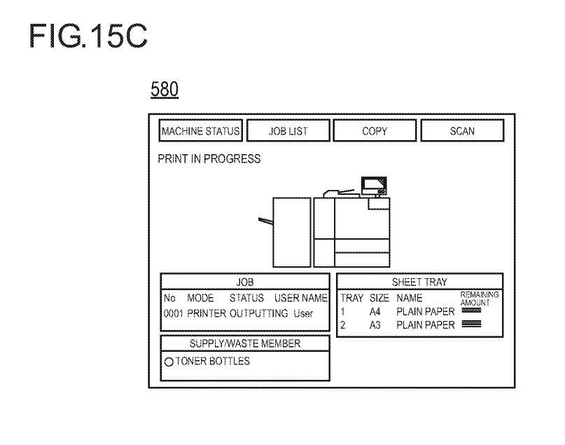

Next, with reference to FIG. 14A to FIG. 15C, the operation of the image forming system 10 according to the present embodiment is described more specifically.

FIG. 14A to FIG. 14C are diagrams for describing an example of the operation of the image forming system 10, and FIG. 15A to FIG. 15C are diagrams showing an example of the screen displayed on the operation panel 103. In the following, a case that the image forming system 10 includes only one paper eject tray is described.

As shown in FIG. 14A, when a paper jam occurs during job execution, the image forming system 10 executes the sheet conveyance stopping process, and moves the sheets 302 to 306 that exist on the upper stream side of the sheet 301 that caused the paper jam on the conveyance path 115 to a predetermined stop position and stops. Then, the image forming system 10 displays a defect notification screen 560 notifying the paper jam (refer to FIG. 15A) on the operation panel 103. The user removes the sheet 301 from the image forming system 10, referring to the guidance information on the defect notification screen 560.

When the sheet 301 is removed from the conveyance path 215 of the image forming system 10, the image forming system 10 performs the automatic purge process, and ejects the sheets 302 to 306 that are remaining on the conveyance path 115 onto a main paper eject tray 205a. As a result, as shown in FIG. 14B, on the main paper eject tray 205a, on a sheet 300a that has been ejected before performing the automatic purge process, the sheets 302 to 306 that are ejected as ineffective sheets by the automatic purge process stack.

When the automatic purge process finishes, the image forming system 10 waits until the start button 103a on the operation panel 103 is pressed by the user. During this period, the operation panel 103 displays a screen 570 showing that the job resumes when the start button 103a is pressed (refer to FIG. 15B).

The user presses the start button 103a after removing the sheets 302 to 306 from the paper eject tray 205a. When the start button 103a is pressed, as shown in FIG. 14C, the image forming system 10 starts the recovery printing and resumes the job that has been suspended because of the paper jam. When the recovery printing starts, the operation panel 103 displays the screen 580 showing that the printing is in progress (refer to FIG. 15C).

As described above, according to the present embodiment, in the case that the image forming system 10 includes only one paper eject tray, the operation mode of the image forming system 10 is determined as the first operation mode. With the described configuration, after the automatic purge process finishes, the job will not resume unless the start button 103a is pressed, so the user can remove the sheets 302 to 306 ejected as ineffective sheets from the paper eject tray 205a before the job resumes. As a result, a case that unnecessary sheets 302 to 306 mix in the printed matter on the paper eject tray 205a is prevented.

Here, when the image forming system 10 includes only one paper eject tray, the operation mode setting based on the user operation may be prohibited. In this case, for example, the operation mode setting is prohibited by disabling or hiding both the “start ejection after jam process” button 401 and the “eject before starting recovery printing” button 402 on the setting screen 400 (refer to FIG. 7).

### Third Embodiment

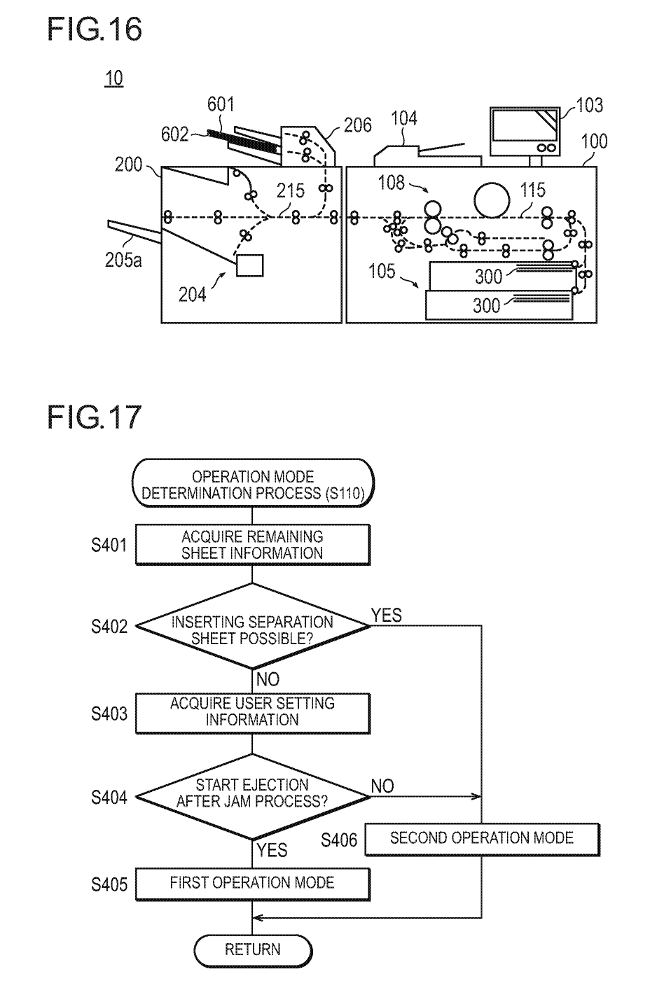

Next, with reference to FIG. 16 to FIG. 19C, the third embodiment of the present invention is described. In the present embodiment, the operation mode of the image forming system 10 is switched in accordance with whether the post-processing apparatus 200 is able to provide a separation sheet or not.

FIG. 16 is a diagram showing a schematic structure of the image forming system 10 according to the present embodiment. The image forming system 10 includes an image forming apparatus 100 that forms an image on a sheet of paper and a post-processing apparatus 200 that performs a post-process on a sheet of paper on which an image is formed by the image forming apparatus 100. In the post-processing apparatus 200 of the present embodiment, two separation sheets 601 and 602 are set in the separation sheet feeder 206.

FIG. 17 is a flowchart showing a procedure of an operation mode determination process according to the present embodiment. Here, the printing process itself according to the present embodiment is the same as that of the first embodiment, so the description about the printing process is omitted.

Firstly, the controller 101 acquires remaining sheet information showing a sheet that remains on the conveyance path from the separation sheet feeder 206 to the paper eject tray 205a (step S401).

Then, the controller 101 determines whether it is possible to insert separation sheets 601 and 602 or not, referring to the remaining sheet information (step S402). For example, when all the sheets 300 remaining in the image forming system 10 exist in the conveyance path in the upper stream side of the separation sheet feeder 206, it is determined that inserting separation sheets 601 and 602 is possible.

When it is determined that inserting separation sheets 601 and 602 is possible (step S402: YES), the controller 101 determines the operation mode of the image forming system 10 as the second operation mode (step S406), and ends the process.

On the other hand, when it is determined that inserting separation sheets 601 and 602 is not possible (step S402: NO), the controller 101 acquires user setting information (step S403). The process of step S403 and after is the same as the process of step S201 and after in FIG. 6, so the detailed description is omitted.

As described above, in the process shown in the flowchart of FIG. 17, whether the image forming system 10 is able to provide separation sheets 601 and 602 or not is determined at first. Then, when it is determined that the image forming system 10 is able to provide separation sheets 601 and 602, the operation mode of the image forming system 10 is determined as the second operation mode. On the other hand, when it is determined that the image forming system 10 is not able to provide separation sheets 601 and 602, the operation mode of the image forming system 10 is determined as the operation mode set by user operation.

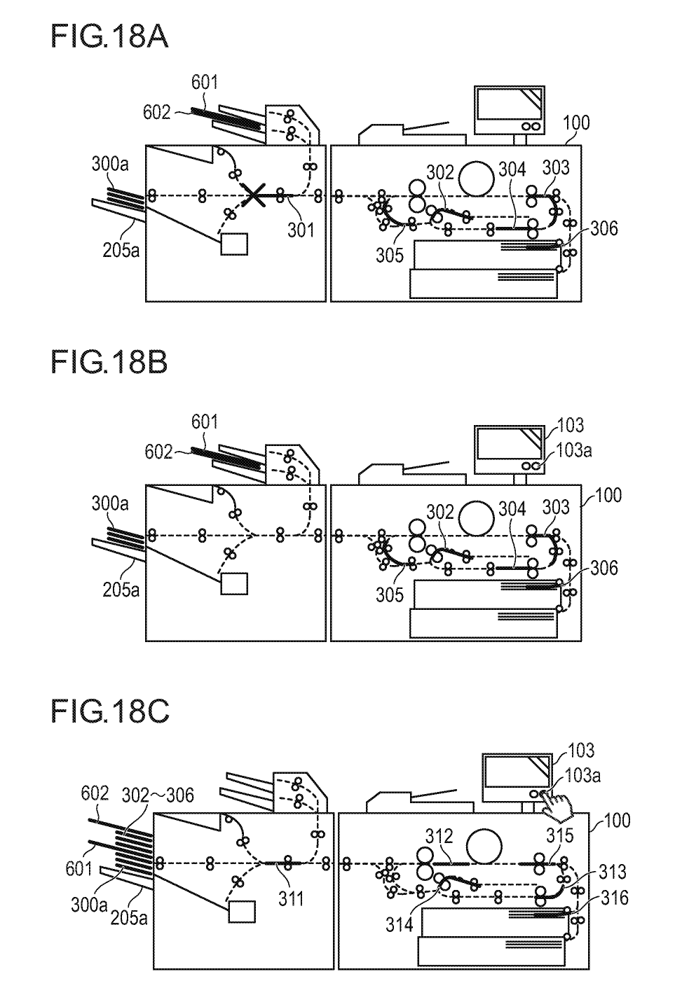

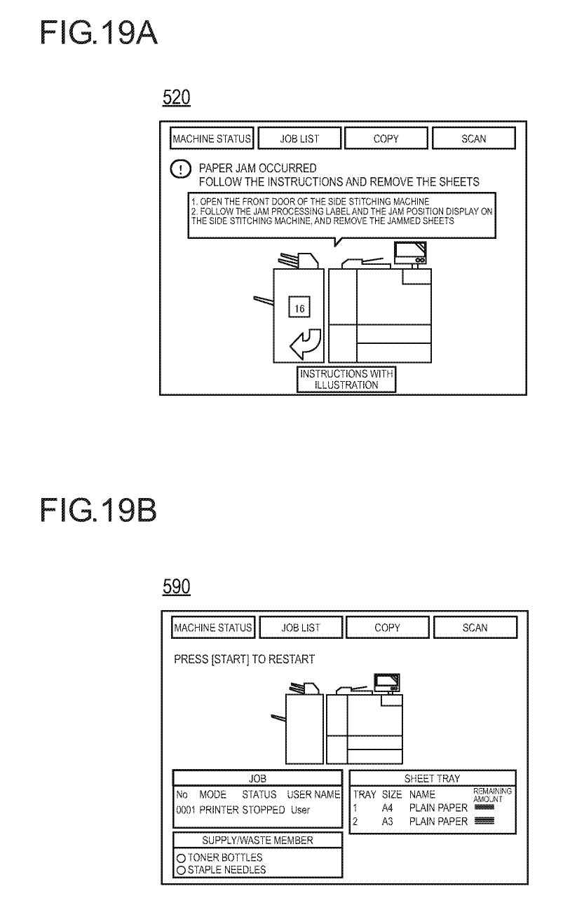

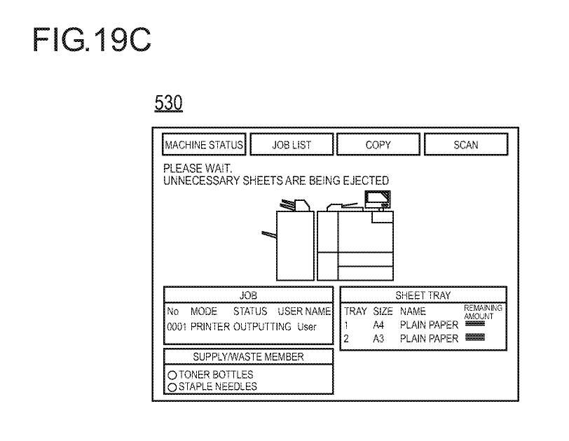

Next, with reference to FIG. 18A to FIG. 19C, the operation of the image forming system 10 according to the present embodiment is described more specifically.

FIG. 18A to FIG. 18C are diagrams for describing an example of the operation of the image forming system 10, and FIG. 19A to FIG. 19C are diagrams showing an example of the screen displayed on the operation panel 103. In the following, a case that the image forming system 10 is able to provide separation sheets 601 and 602 is described.

As shown in FIG. 18A, when a paper jam occurs during job execution, the image forming system 10 executes the sheet conveyance stopping process, and moves the sheets 302 to 306 that exist on the upper stream side of the sheet 301 that caused the paper jam on the conveyance path to a predetermined stop position and stops. Then, the image forming system 10 displays the defect notification screen 520 notifying the paper jam (refer to FIG. 19A) on the operation panel 103. The user removes the sheet 301 from the image forming system 10, referring to the guidance information on the defect notification screen 520.

When the sheet 301 is removed from the conveyance path of the image forming system 10, as shown in FIG. 18B, the image forming system 10 waits until the start button 103a on the operation panel 103 is pressed by the user. During this period, the operation panel 103 displays a screen 590 showing that the automatic purge process is performed and the job resumes when the start button 103a is pressed (refer to FIG. 19B).

Then, when the user presses the start button 103a, the image forming system 10 ejects the separation sheet 601 onto the paper eject tray 205a at first. Then, the image forming system 10 performs the automatic purge process, and ejects the sheets 302 to 306 that are remaining on the conveyance path 115 onto the paper eject tray 205a. During this period, the operation panel 103 displays the screen 530 showing that the sheets 302 to 306 are being ejected as ineffective sheets (refer to FIG. 19C).

When the automatic purge process finishes, the image forming system 10 immediately starts a recovery printing after ejecting the separation sheet 602 onto the paper eject tray 205a. As a result, as shown in FIG. 18C, on the paper eject tray 205a, between the sheets 300a, 311 to 316 that are ejected before starting or after finishing the automatic purge process and the sheets 302 to 306 that are ejected as ineffective sheets by the automatic purge process, separation sheets 601 and 602 are inserted. By inserting the separation sheets 601 and 602, finding the unnecessary sheets 302 to 306 among the printed matter becomes easy.

As described above, according to the present embodiment, in the case that the image forming system 10 is able to provide separation sheets 601 and 602, the operation mode of the image forming system 10 is determined as the second operation mode. With the described configuration, the sheets 302 to 306 that are ejected as ineffective sheets by the automatic purge process are distinguished from other sheets 300a, 311 to 316, so the user does not need to remove the unnecessary sheets 302 to 306 from the paper eject tray before the job resumes. Therefore, after removing the sheet 301 that caused the paper jam from the image forming system 10, the user can press the start button 103a and then immediately go away from the front of the image forming system 10.

In the above-described embodiment, the separation sheets 601 and 602 are stacked under and over the sheets that are ejected as ineffective sheets by the automatic purge process. However, unlike the present embodiment, the separation sheet may be stacked one of under and over the sheets that are ejected as ineffective sheets by the automatic purge process.

Moreover, in the above-described embodiment, when separation sheets are able to be provided, the process to insert separation sheets and distinguish the sheets is performed in a higher priority than the process of ejecting a sheet by the automatic purge process onto the sub paper eject tray 205b. However, the priority of the two processes are not limited to this order, and when equal to or more than two paper eject trays are provided, the process of ejecting a sheet by the automatic purge process onto the sub paper eject tray 205b may be performed in a higher priority than the process of providing separation sheets.

### Fourth Embodiment

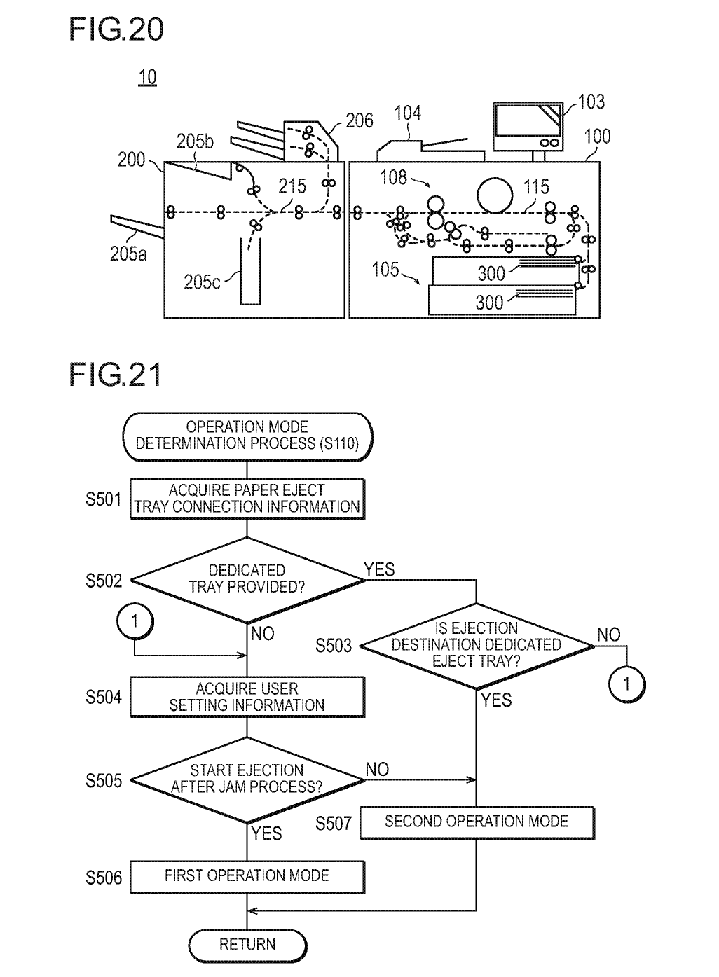

Next, with reference to FIG. 20 to FIG. 23C, the fourth embodiment of the present invention is described. In the present embodiment, the operation mode of the image forming system 10 is switched in accordance with whether the post-processing apparatus 200 includes a dedicated paper eject tray for an ineffective sheet or not.

FIG. 20 is a diagram showing a schematic structure of the image forming system 10 according to the present embodiment. The image forming system 10 includes an image forming apparatus 100 that forms an image on a sheet of paper and a post-processing apparatus 200 that performs a post-process on a sheet of paper on which an image is formed by the image forming apparatus 100. The post-processing apparatus 200 of the present embodiment includes a dedicated paper eject tray 205c onto which ineffective sheets are ejected.

FIG. 21 is a flowchart showing a procedure of an operation mode determination process according to the present embodiment. Here, the printing process itself according to the present embodiment is the same as the first embodiment, so the description about the printing process is omitted.

Firstly, the controller 101 acquires paper eject tray connection information showing the configuration of the paper eject tray included in the image forming system 10 (step S501).

Then, the controller 101 determines whether a dedicated paper eject tray 205c onto which the ineffective sheet is ejected is provided or not, referring to the paper eject tray connection information (step S502).

When it is determined that the dedicated paper eject tray 205c is provided (step S502: YES), the controller 101 determines whether the ejection destination of the ineffective sheet is the dedicated paper eject tray 205c or not (step S503). For example, in a case that all the sheets remaining in the image forming system 10 exist on the upper stream side of the dedicated paper eject tray 205c on the conveyance path, it is determined that the ejection destination of the ineffective sheet is the dedicated paper eject tray 205c.

When it is determined that the ejection destination of the ineffective sheet is the dedicated paper eject tray 205c (step S503: YES), the controller 101 determines the operation mode of the image forming system 10 as the second operation mode (step S507), and ends the process.

On the other hand, when it is determined that the dedicated paper eject tray 205c is not provided (step S502: NO), or the ejection destination of the ineffective sheet is not the dedicated paper eject tray 205c (step S503: NO), the controller 101 acquires user setting information (step S504). The process of step S504 and after is the same as the process of step S201 and after in FIG. 6, so the detailed description is omitted.

As described above, in the process shown in the flowchart of FIG. 21, when the image forming system 10 includes the dedicated paper eject tray 205c for an ineffective sheet and the ejection destination of the ineffective sheet is the dedicated paper eject tray 205c, the operation mode of the image forming system 10 is determined to be the second operation mode. On the other hand, when the image forming system 10 does not include the dedicated paper eject tray 205c, or the ejection destination of the ineffective sheet is not the dedicated paper eject tray 205c, the operation mode of the image forming system 10 is determined as the operation mode set by the user operation.

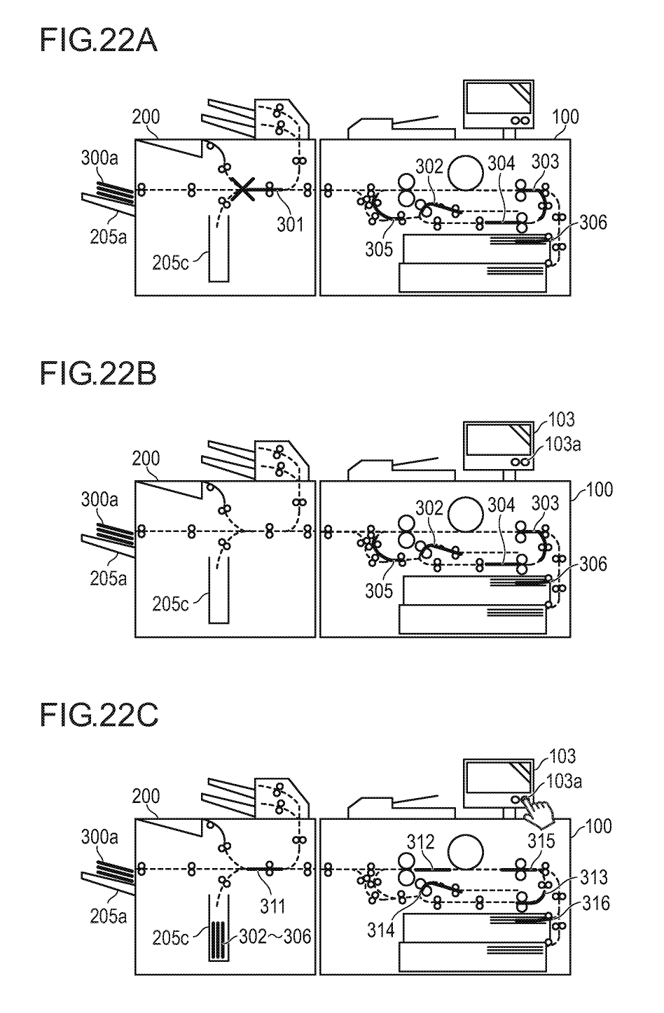

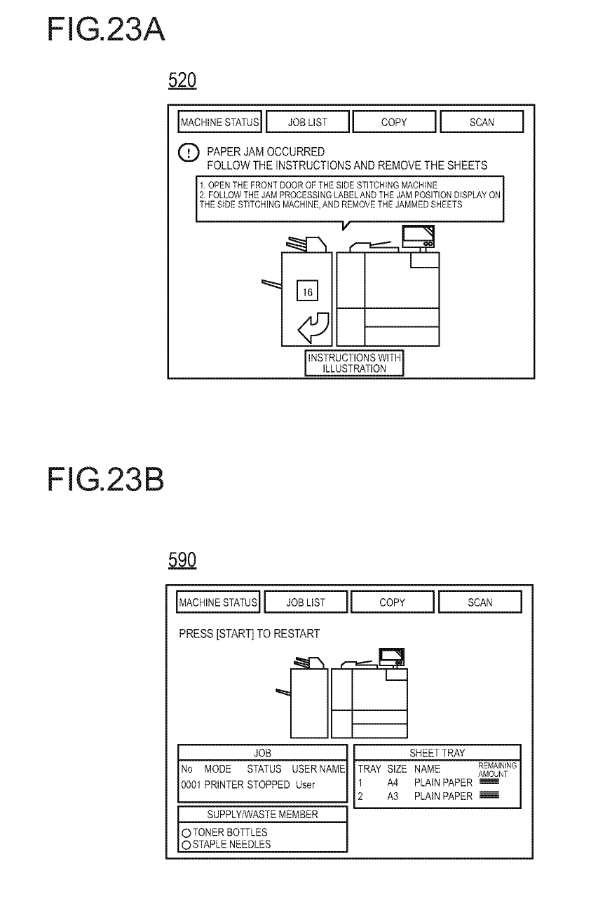

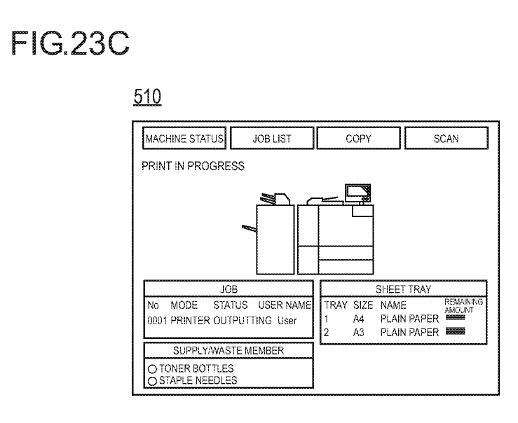

Next, with reference to FIG. 22A to FIG. 23C, the operation of the image forming system 10 according to the present embodiment is described more specifically.

FIG. 22A to FIG. 22C are diagrams for describing an example of the operation of the image forming system 10, and FIG. 23A to FIG. 23C are diagrams showing an example of the screen displayed on the operation panel 103. In the following, a case that the image forming system 10 includes the dedicated paper eject tray 205c, and an ineffective sheet is ejected to the dedicated paper eject tray 205c is described.

As shown in FIG. 22A, when a paper jam occurs during job execution, the image forming system 10 executes the sheet conveyance stopping process, and moves the sheets 302 to 306 that exist on the upper stream side of the sheet 301 that caused the paper jam on the conveyance path to a predetermined stop position and stops. Then, the image forming system 10 displays the defect notification screen 520 notifying the paper jam (refer to FIG. 23A) on the operation panel 103. The user removes the sheet 301 from the image forming system 10, referring to the guidance information on the defect notification screen 520.

When the sheet 301 is removed from the conveyance path of the image forming system 10, as shown in FIG. 22B, the image forming system 10 waits until the start button 103a on the operation panel 103 is pressed by the user. During this period, the operation panel 103 displays the screen 590 showing that the automatic purge process is performed and the job resumes when the start button 103a is pressed (refer to FIG. 23B).

When the user presses the start button 103a, as shown in FIG. 22C, the image forming system 10 performs the automatic purge process, and ejects the sheets 302 to 306 that are remaining on the conveyance path 115 to the dedicated paper eject tray 205c. When the automatic purge process finishes, the image forming system 10 immediately starts the recovery printing. When the recovery printing starts, the operation panel 103 displays the screen 510 showing that the printing is in progress (refer to FIG. 23C).

As described above, according to the present embodiment, in the case that the ineffective sheet is ejected onto the dedicated paper eject tray 205c of the image forming system 10, the operation mode of the image forming system 10 is determined as the second operation mode. As it is not needed to remove the ineffective sheet from the paper eject tray 205c until the dedicated paper eject tray 205c is full, the user can press the start button 103a and then immediately go away from the front of the image forming system 10, after removing the sheet 301 that caused the paper jam from the image forming system 10.

### Fifth Embodiment

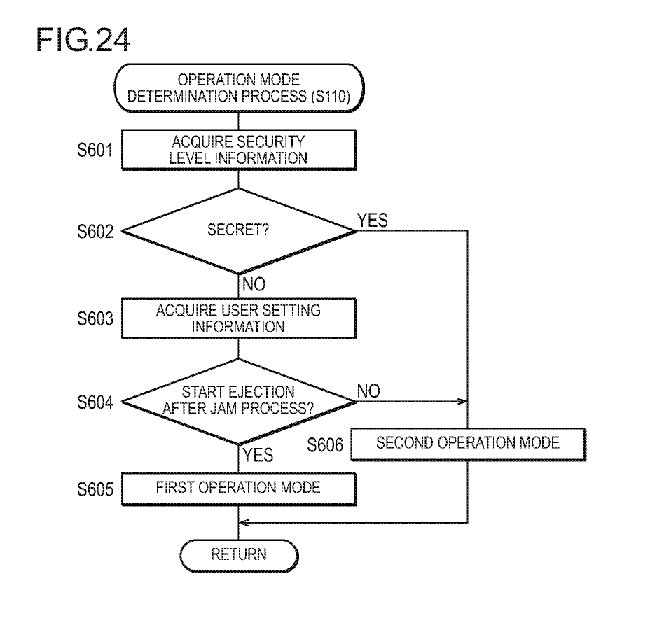

Next, with reference to FIG. 24, the fifth embodiment of the present invention is described. In the present embodiment, the operation mode of the image forming system is switched in accordance with a job security level.

FIG. 24 is a flowchart showing a procedure of an operation mode determination process according to the present embodiment. Here, the configuration itself of the image forming system 10 according to the present embodiment is the same as that of the first embodiment, so the description about the configuration of the image forming system 10 is omitted. Moreover, the printing process itself according to the present embodiment is the same as that of the first embodiment, so the description about the printing process is omitted.

Firstly, the controller 101 analyzes a job and acquires security level information showing the security level set to the job (step S601).

Then, the controller 101 determines whether the security level of the job is secret or not, referring to the security level information (step S602).

When it is determined that the security level of the job is secret (step S602: YES), the controller 101 determines the operation mode of the image forming system 10 as the second operation mode (step S606), and ends the process.

On the other hand, when it is determined that the security level of the job is not secret (step S602: NO), the controller 101 regards the security level of the job as ordinary, and acquires user setting information (step S603). The process of step S603 and after is the same as the process of step S201 and after in FIG. 6, so the detailed description is omitted.

As described above, in the process shown in the flowchart of FIG. 24, whether the security level of the job is secret or not is determined at first. Then, when it is determined that the security level of the job is secret, the operation mode of the image forming system 10 is determined as the second operation mode. On the other hand, when it is determined that the security level of the job is ordinary, the operation mode of the image forming system 10 is determined as the operation mode set by the user operation.

With the described configuration, when the security level of the job is high, the automatic purge process will not be performed unless the start button 103a is pressed after a sheet that caused the paper jam is removed. Therefore, a case that a secret sheet remaining in the image forming system 10 is ejected onto the sub paper eject tray 205b and the like regardless of the will of the user is prevented.

Here, in the above-described embodiment, two levels “secret” and “ordinary” are set as job security levels. However, unlike the present embodiment, equal to or more than three levels can be set as job security levels. In this case, when it is determined that the security level of the job is equal to or higher than a predetermined level, the operation mode of the image forming system 10 is determined as the second operation mode.

### Sixth Embodiment

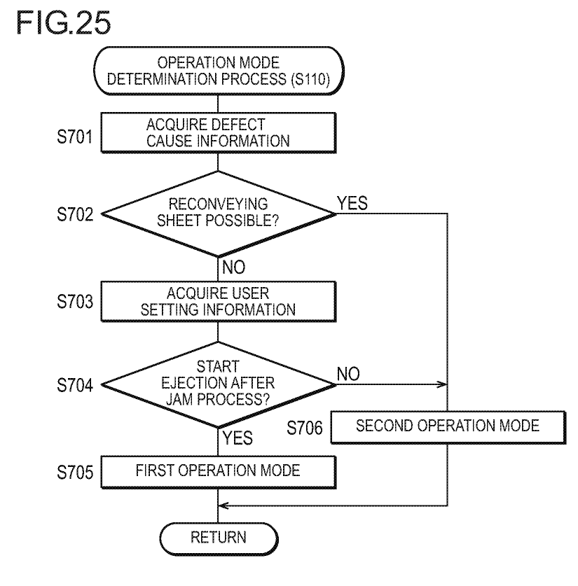

Next, with reference to FIG. 25, the sixth embodiment of the present invention is described. In the present embodiment, the operation mode of the image forming system is switched in accordance with a cause of a conveyance defect.

FIG. 25 is a flowchart showing a procedure of an operation mode determination process according to the present embodiment. Here, the configuration itself of the image forming system 10 according to the present embodiment is the same as that of the first embodiment, so the description about the configuration of the image forming system 10 is omitted. Moreover, in the printing process according to the present embodiment, the process shown in the step S111 of FIG. 4 is omitted, and the sheet that caused the conveyance defect is ejected by the automatic purge process.

Firstly, the controller 101 acquires defect cause information showing a cause of a conveyance defect of a sheet (step S701).

Then, the controller 101 determines whether it is possible to reconvey the sheet that caused the conveyance defect or not, referring to the defect cause information (step S702). Here, the controller 101 determines that the reconveying of the sheet that caused the conveyance defect is possible when the cause shown by the defect cause information is a paper deviation, a paper skew, a double feeding, or an image preparation incomplete. Here, the paper deviation is a deviation of a sheet where there is no problem in conveying the sheet, but the sheet is deviated so that image adjustment is impossible. Moreover, the paper skew is an inclination of a sheet where there is no problem in conveying the sheet, but the degree of inclination is equal to or more than predetermined amount.

When it is determined that reconveying the sheet that caused the conveyance defect is possible (step S702: YES), the controller 101 determines the operation mode of the image forming system 10 as the second operation mode (step S706), and ends the process.

On the other hand, when it is determined that reconveying the sheet that caused the conveyance defect is not possible (step S702: NO), the controller 101 acquires user setting information (step S703). The process of step S703 and after is the same as the process of step S201 and after in FIG. 6, so the detailed description is omitted.

As described above, in the process shown in the flowchart of FIG. 25, whether reconveying the sheet that caused the conveyance defect is possible or not is determined at first. Then, when it is determined that reconveying the sheet that caused the conveyance defect is possible, the operation mode of the image forming system 10 is determined as the second operation mode. On the other hand, when it is determined that reconveying the sheet that caused the conveyance defect is not possible, the operation mode of the image forming system 10 is determined as the operation mode set by the user operation.

When it is possible to reconvey the sheet that caused the conveyance defect, since the user does not need to remove the sheet that caused the conveyance defect, the user can press the start button 103a and then immediately go away from the front of the image forming system 10.

Here, in the above-described embodiment, the controller 101 of the image forming apparatus 100 functions as a determination unit that determines whether conveying the sheet that caused the conveyance defect is possible or not, by executing a corresponding program.

The present invention is not limited to the above-described first to sixth embodiments, and various modifications are possible within the scope of the claims

For example, in the first to sixth embodiments described above, in the case that the operation mode of the image forming system 10 is the first operation mode, after the sheet that caused the conveyance defect is removed by the user, the automatic purge process is performed continually However, when the operation mode of the image forming system 10 is the first operation mode, after the sheet that caused the conveyance defect is removed by the user, in a case that the start button 103a on the operation panel 103 is pressed by the user, the automatic purge process may be performed. In this case, after the automatic purge process finishes, when the user presses the start button 103a again, the job resumes.

Also, in the first to sixth embodiments described above, when the operation mode of the image forming system 10 is the second operation mode, after the sheet that caused the conveyance defect is removed by the user, in the case that the start button 103a on the operation panel 103 is pressed by the user, the automatic purge process is performed. However, when the operation mode of the image forming system 10 is the second operation mode, after the sheet that caused the conveyance defect is removed by the user, the automatic purge process may be performed continually without waiting for the start button 103a to be pressed.

Also, in the first to sixth embodiments described above, the image forming system is configured to be able to switch the operation mode between the first operation mode and the second operation mode. However, the image forming system may be configured not to be able to switch the operation mode, and may always operate in the first operation mode.

Also, in the first to sixth embodiments described above, in the case that the operation mode of the image forming system 10 is the first operation mode, after the automatic purge process finishes, a predetermined signal is generated by pressing the start button 103a on the operation panel 103, and in the case that the predetermined signal is recognized, the job restarted. However, the signal to restart the job after finishing the automatic purge process is not limited to a signal that is generated when the start button 103a is pressed, but various signals generated on the basis of a user action can be used. For example, a sensor may be mounted on the paper eject tray that senses that sheets are removed from the paper eject tray, and the signal outputted by the sensor of the paper eject tray may be used. In this case, in a case that the user removes the sheet that is ejected as an ineffective sheet by the automatic purge process from the paper eject tray, the sensor mounted on the paper eject tray generates the predetermined signal, and when the predetermined signal is recognized, the job restarts.

Also, in the first to sixth embodiments described above, the image forming system that the image forming apparatus and the post-processing apparatus are separately configured is described as an example. However, the image forming system of the present invention is not limited to one that the image forming apparatus and the post-processing apparatus are separately configured, and the image forming apparatus and the post-processing apparatus may be integrally configured. Otherwise, the image forming system of the present invention may be configured with the image forming apparatus alone.

The units and method for performing various processes on the image forming system according to the above-described embodiment are able to be realized by ether a dedicated hardware circuit or a programmed computer. The above-described program may be provided in a computer readable storage medium such as a compact disc read only memory (CD-ROM), or may be provided online via a network such as the Internet. In this case, a program stored on a computer readable storage medium is usually transferred to a storage such as a hard disk. Also, the above-described program may be provided as independent application software, or may be incorporated in software of the apparatus as a function of the image forming system.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming system that performs an image formation on a basis of a job, comprising:
a paper conveyer that conveys a sheet along a conveyance path;
an image former that is provided on the conveyance path and forms an image on a sheet conveyed along the conveyance path;
a paper eject tray that is provided on an downstream side of the image former in a conveyance direction and onto which a sheet conveyed along the conveyance path is ejected; and
a controller that recognizes a predetermined signal generated on a basis of a user action and, in a case that a conveyance defect occurs on a sheet conveyed on the conveyance path during job execution, controls the paper conveyer to perform an automatic purge process that conveys a sheet remaining on the conveyance path and ejects the sheet onto the paper eject tray after the sheet that caused the conveyance defect is removed from the conveyance path,
wherein, the image forming system is configured to be able to switch an operation mode between a first operation mode and a second operation mode, and
in a case that the operation mode is the first operation mode, the controller performs a control to resume the job suspended because of the conveyance defect when the predetermined signal is recognized after the automatic purge process finishes; and
in a case that the operation mode is the second operation mode, the controller performs a control to continually resume the job suspended because of the conveyance defect without waiting for the predetermined signal to be recognized after the automatic purge process finishes.

2. The image forming system as claimed in claim 1, wherein the controller determines the operation mode on a basis of at least one information of an information about the paper eject tray, an information about the job, and an information about the conveyance defect.

3. The image forming system as claimed in claim 1, wherein the operation mode is set on a basis of a user operation, and the controller determines the operation mode as the operation mode set by the user operation.

4. The image forming system as claimed in claim 1, wherein, in a case that the number of the paper eject trays is one, the controller determines the operation mode as the first operation mode.

5. The image forming system as claimed in claim 3, wherein, in a case that the number of the paper eject trays is one, the controller prohibits a setting of the operation mode on a basis of the user operation, and determines the operation mode as the first operation mode.

6. The image forming system as claimed in claim 1, wherein, in a case that a sheet can be provided to distinguish a sheet ejected by the automatic purge process and a sheet ejected before starting or after finishing the automatic purge process, the controller determines the operation mode as the second operation mode.

7. The image forming system as claimed in claim 1, further comprising:
a dedicated paper eject tray that accommodates a sheet ejected by the automatic purge process,
wherein, in a case that a sheet is ejected onto the dedicated paper eject tray by the automatic purge process, the controller determines the operation mode as the second operation mode.

8. The image forming system as claimed in claim 1, wherein, in a case that a security level of the job is equal to or higher than a predetermined level, the controller determines the operation mode as the second operation mode.

9. The image forming system as claimed in claim 1, wherein the controller determines whether it is possible to convey the sheet that caused the conveyance defect or not and, in a case that conveying the sheet that caused the conveyance defect is determined to be possible, the controller determines the operation mode as the second operation mode.

10. The image forming system as claimed in claim 9, wherein the controller determines that conveying the sheet that caused the conveyance defect is possible when a cause of the conveyance defect is a paper deviation, a paper skew, a double feeding, or an image preparation incomplete.

11. A job execution method utilized in an image forming system, wherein the image forming system is configured to be able to switch an operation mode between a first operation mode and a second operation mode, and the method comprises:
(a) in a case that a conveyance defect occurs on a sheet conveyed on a conveyance path during job execution, performing an automatic purge process that conveys a sheet remaining on the conveyance path and ejects the sheet onto a paper eject tray after the sheet that caused the conveyance defect is removed from the conveyance path;
(b) in a case that the operation mode is the first operation mode, recognizing a predetermined signal generated on a basis of a user action after the automatic purge process finishes and, when the predetermined signal is recognized, resuming the job suspended because of the conveyance defect; and
(c) in a case that the operation mode is the second operation mode, after the automatic purge process finishes, continually resuming the job suspended because of the conveyance defect.

12. A non-transitory computer readable storage medium storing a job execution program to be executed on an image forming system, wherein the image forming system is configured to be able to switch an operation mode between a first operation mode and a second operation mode, and the program causes a computer to perform:
(a) in a case that a conveyance defect occurs on a sheet conveyed on a conveyance path during job execution, performing a control to perform an automatic purge process that conveys a sheet remaining on the conveyance path and ejects the sheet onto a paper eject tray after the sheet that caused the conveyance defect is removed from the conveyance path;
(b) in a case that the operation mode is the first operation mode, recognizing a predetermined signal generated on a basis of a user action after the automatic purge process finishes and, when the predetermined signal is recognized, performing a control to resume the job suspended because of the conveyance defect; and
(c) in a case that the operation mode is the second operation mode, after the automatic purge process finishes, performing a control to continually resume the job suspended because of the conveyance defect.
